(19) United States
(12) Patent Application Publication
(10) Pub. No.: US 2012/0092874 A1
(43) Pub. Date: Apr. 19, 2012

(54) Light-guiding pillar

(76) Inventor: Chao-Liang Lin, Qingshui Township (TW)

(21) Appl. No.: 12/925,207

(22) Filed: Oct. 15, 2010

(51) Int. Cl. F21V 7/00

(52) U.S. Cl. 362/296.01

(57) ABSTRACT

A light-guiding pillar has a main body and an LED mount. The main body is a strip pervious to light and has a first surface and multiple refracting grooves formed in the main body at intervals. The LED mount is pervious to light, is mounted securely on and connected integrally with the main body as a single part and has an LED hole and a reflecting surface. The LED hole is formed in the LED mount. The reflecting surface is connected to the first surface of the main body, is inclined relative to the first surface of the main body and is capable of totally reflecting light from the LED hole and making the light travel into the main body. The present invention only requires one LED to provide a wide range of illumination and to use one LED saves cost and electricity.

### BACKGROUND OF THE INVENTION

1. Field of the Invention

The present invention relates to a light-guiding pillar, and more particularly to a light-guiding pillar providing a wide range of illumination.

2. Description of Related Art

The technology of LED (light emitting diode) has grown by leaps and bounds and IC (integral circuit) chips and heat-dissipating modules have greatly advanced in these years, so LEDs are widely applied to a variety of fields and industries, such as low-power indicator light, back light of cell phone keypad and LED backlight modules with low power consumption, long lifespan and high CRI (color rendering index).

A conventional LED pillar has a long main body and multiple LEDs. The LEDs are mounted securely on the pillar at intervals to provide a wide range of illumination. However, multiple LEDs require a high manufacturing cost and greatly consume electricity.

To overcome the shortcomings, the present invention tends to provide a light-guiding pillar to mitigate the aforementioned problems.

### SUMMARY OF THE INVENTION

The main objective of the invention is to provide a light-guiding pillar providing a wide range of illumination.

A light-guiding pillar has a main body and an LED mount. The main body is a pillar pervious to light and has a first surface and multiple refracting grooves formed in the main body at intervals. The LED mount is pervious to light, is mounted securely on and connected integrally with the main body as a single part and has an LED hole and a reflecting surface. The LED hole is formed in the LED mount. The reflecting surface is connected to the first surface of the main body, is inclined relative to the first surface of the main body and is capable of totally reflecting light from the LED hole and making the light travel into the main body. The present invention only requires one LED to provide a wide range of illumination and to use one LED saves cost and electricity.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a light-guiding pillar in accordance with the present invention;

FIG. 2 is an enlarged partially exploded perspective view of the light-guiding pillar in FIG. 1;

FIG. 3 is a side view in partial section of the light-guiding pillar in FIG. 2; and

FIG. 4 is an enlarged side view of the light-guiding pillar in FIG. 3.

### DETAILED DESCRIPTION OF PREFERRED EMBODIMENT

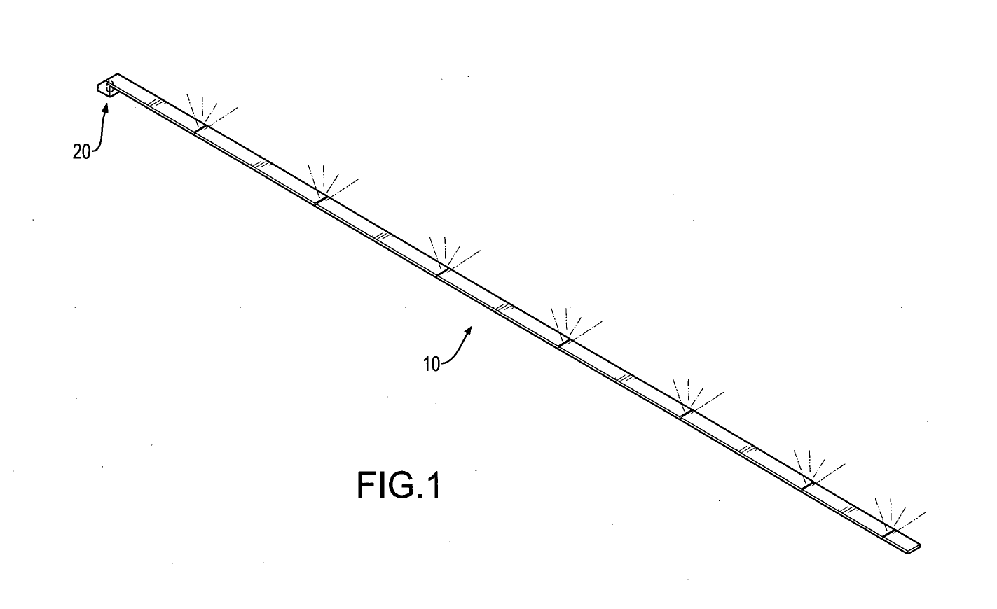

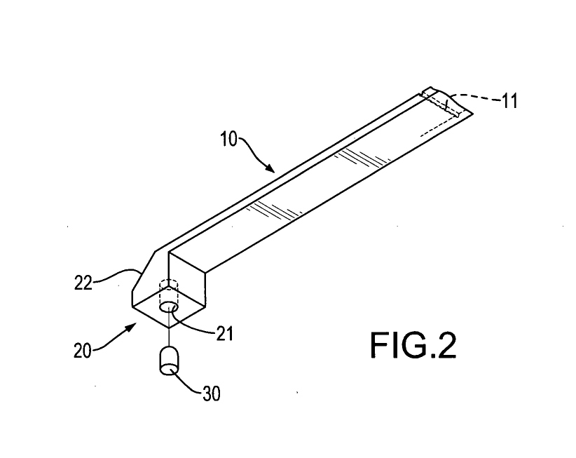

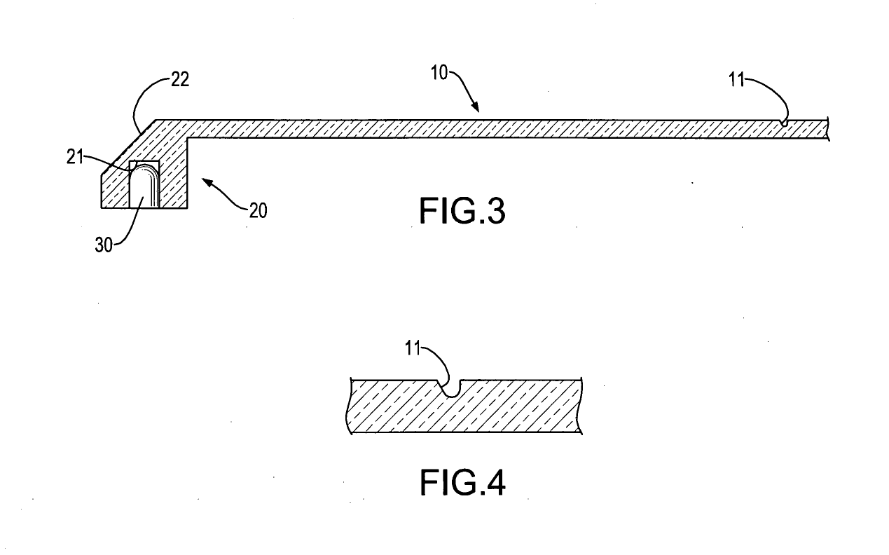

With reference to FIGS. 1 to 4, a light-guiding pillar in accordance with the present invention comprises a main body 10 and an LED mount 20.

The main body 10 is a strip pervious to light and has a first surface, a second surface, multiple refracting grooves 11, a connecting end and a cross sectional shape. The first surface is opposite to the second surface of the main body 10 and is a narrow rectangle. The refracting grooves 11 are formed in the first surface of the main body 10 at intervals, are linear and are parallel to one another. The cross sectional shape of the main body 10 is rectangular.

The LED mount 20 is pervious to light, is mounted securely at the connecting end on the second surface of the main body 10, is connected integrally with the main body 10 as a single part and has an LED hole 21 and a reflecting surface 22. The LED hole 21 is formed in the LED mount 20. The reflecting surface 22 is opposite to the LED hole 21, is connected to the first surface of the main body 10, is inclined relative to the first surface of the main body 10 and has an inclination.

An LED 30 is put in the LED hole 21 and emits light toward the reflecting surface 22. Preferably, an axis of the LED hole 21 is perpendicular to the second surface of the main body 10, such that light emitted from the LED 30 is perpendicular to the main body 10.

Light emitted from the LED 30 is reflected by the reflecting surface 22 because the inclination of the reflecting surface 22 is capable of making an incident angle of light from the LED 30 larger than a particular critical angle with respect to a normal of the reflecting surface 22. Thereafter, light reflected by the reflecting surface 22 travels into the main body 10. When light traveling in the main body 10 meets one of the refracting grooves 11, light can be refracted to travel into the atmosphere or be reflected back. Consequently, part of light traveling in the main body 10 emits out from the refracting grooves 11 for illumination.

The LED 30 may emit blue light or any possible visible light. The present invention does not limit the color of light emitted from the LED 30.

From the above description, it is noted that the present invention has the following advantage: the present invention only requires one LED 30 to provide a wide range of illumination. To use one LED saves cost and electricity and facilitates to provide illumination in case of emergency. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light-guiding pillar comprising:
a main body being a strip pervious to light and having
a first surface;
a second surface opposite to the first surface of the main body; and
multiple refracting grooves formed in the main body at intervals; and
an LED (light emitting diode) mount being pervious to light, mounted securely on and connected integrally with the main body as a single part and having
an LED hole formed in the LED mount; and
a reflecting surface connected to the first surface of the main body, inclined relative to the first surface of the main body and capable of totally reflecting light from the LED hole and making the light travel into the main body.

2. The light-guiding pillar as claimed in claim 1, wherein
an axis of the LED hole is perpendicular to the second surface of the main body; and
the reflecting surface has an inclination capable of making an incident angle of the light from the LED hole larger than a particular critical angle with respect to a normal of the reflecting surface.

3. The light-guiding pillar as claimed in claim 2, wherein the main body has a rectangular cross sectional shape;
the refracting grooves are formed in the first surface of the main body; and
the LED mount is mounted securely on the second surface of the main body.

4. The light-guiding pillar as claimed in claim 1, wherein the main body has a rectangular cross sectional shape;
the refracting grooves are formed in the first surface of the main body; and
the LED mount is mounted securely on the second surface of the main body.

5. The light-guiding pillar as claimed in claim 1, wherein the refracting grooves are linear and parallel to one another.

6. The light-guiding pillar as claimed in claim 2, wherein the refracting grooves are linear and parallel to one another.

7. The light-guiding pillar as claimed in claim 3, wherein the refracting grooves are linear and parallel to one another.

8. The light-guiding pillar as claimed in claim 4, wherein the refracting grooves are linear and parallel to one another.
